(19) United States
(12) Patent Application Publication
(10) Pub. No.: US 2007/0022300 A1
(43) Pub. Date: Jan. 25, 2007

(54) MEMORY BASED AUTHENTICATION SYSTEM

(76) Inventors: David Eppert, Vancouver (CA); Martin L. Renaud, Maple Ridge (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 11/161,116

(22) Filed: Jul. 22, 2005

(51) Int. Cl. H04L 9/00

(52) U.S. Cl. 713/183

(57) ABSTRACT

An authentication system for authenticating an identity of a user which has a database having a plurality of training questions about the user's past and a corresponding testing question for each of the training questions stored thereon. The authentication system also has a central processing unit (CPU) coupled to the database and is operative in both a training session and a testing session to select a sub-set of the training questions and to pose them to the user, store user responses to the subset of training questions in the user's profile and, in said testing session and to select a subset of the testing questions. The subset of testing questions is posed to the user and the responses of said user to said subset of test questions checked against the user's profile. Each of the testing questions is based on a corresponding training question without a context.

### FIELD

The present invention relates to a user authentication system based upon memories and memory processes. Unique life experiences are used to ensure others do not gain access to personal information.

### BACKGROUND

Authenticating the user of a computer system is the process of determining that the user is who he/she claims to be. The most common authentication technique is the user name and password. The former provides identity credentials while the latter provides authentication credentials. When faced with choosing a password of 5-10 characters in length, composed of letters and numbers, most people choose short, simple passwords that can be easily remembered. Modern computers can ascertain such passwords very easily. Moreover, using such passwords for long periods of time or on multiple systems increases the risk of that password being compromised. Some systems force a user to rotate or change their passwords on a regular basis but this makes the memory burden of a password system much larger and people tend to make less secure password choices if they are forced to make them often. Sharing passwords with spouses, secretaries, etc. for convenience, compromises the ability of a system to uniquely identify an individual and increases the chance that a password will be misused.

Hardware authentication is another type of authentication, which requires the presence of the hardware token, which is commonly a card with a magnetic strip. Token authentication does not require the presence of the “true” person. Such authentication systems are expensive and yet confirm only the presence of the person with the token.

Biometric implementations of authentication systems can be static such as fingerprints, eye retinas and irises, voice patterns, facial patterns and hand measurements, or dynamic such as signature, gait, voice or typing. Static biometrics are relatively easy to measure, and the technology comparatively mature. Authentication systems that rely on static biometrics must be carefully implemented because poorly implemented systems can be subject to particularly pernicious forms of identity theft. For example, the theft of a thumbprint can have long-lasting implications, since—unlike a password—it is not easily changed.

Dynamic biometrics are unique, often unconscious behaviors of an individual. Signature biometrics measures the manner in which an individual creates his/her signature and not just the static visual image of his/her signature. Dynamic features measured include speed, pen pressure, vector, stroke length and pen-lifts. Authentication systems that rely on dynamic biometrics do not suffer from the identity theft issues to which static biometrics are prone. However strong, dynamic biometric authentication systems are expensive and require a hardware device to take the required measurements at every access point. For example, if the user has a dynamic signature tablet for authentication on their office desktop computer, he/she will need another similar device at home to achieve the same level of security when working from home, effectively doubling the cost of the solution.

There is clearly needed in the marketplace a mechanism as simple and as easy to use as a password.

### SUMMARY OF THE INVENTION

According to the invention there is provided an authentication system for authenticating an identity of a user which has a database having a plurality of training questions about the user's past and a corresponding testing question for each of the training questions stored thereon. The authentication system also has a central processing unit (CPU) coupled to the database and is operative in both a training session and a testing session to select a sub-set of the training questions and to pose them to the user, store user responses to the subset of training questions in the user's profile and, in said testing session to select a subset of the testing questions. The subset of testing questions is posed to the user and the responses of said user to said subset of test questions checked against the user's profile. Each of the testing questions is based on a corresponding training question without a context.

Key words in the training questions are replicated in the test questions so that both the training questions and the corresponding testing questions have the same key words. The repetition of those words assists users in providing the same answers to corresponding training and testing questions.

Advantageously, the system augments current authentication systems already in place. For example, access to the authentication system can be controlled by a conventional user name and password sign-on protocol.

Responses to questions may be made by selecting a letter on an alphabetic selection grid.

Advantageously, the database has a log of pass and fail recordals for each training/test question pair and for each user.

Advantageously, a time out circuit monitors and is operative to limit the duration of each of the training and test questions.

Advantageously, each of the training questions follows a common format so that users may easily and consistently follow instructions.

A central processing unit (CPU) is coupled to the database and is operative to select a subset of training and testing questions wherein the testing questions in a subset of testing questions are randomly selected.

Preferably, the training questions do not elicit any identifying information. Thus the system operates without storing any information that could be used to determine a person's identity.

Advantageously, a performance monitor records passes and fails for each test question for each user.

Preferably, an ID monitor records session identification time and computes and records average session identification time.

In another aspect of the invention there is provided a method of authentication, which includes providing a database having training questions and testing questions, user responses to those training questions and identity information as part of a user profile. Each of the testing questions is based on a corresponding training question, however, the testing question lacks context. The training questions are questions about events in the user's past life. During a training session a subset of the training questions is selected from the database and displayed to the user. The method further includes storing responses to said training questions in the user profile on said database and, during a testing session, randomly selecting subsets of the training questions from the database and displaying those training questions to the user, storing responses to the training questions in the user profile on the database, selecting a subset of the testing questions from the database and displaying those testing questions to the user and checking a response to each question of the subset of testing questions against responses stored in the user profile to determine if the response to the testing question is a pass or fail.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram of the authentication system and a user;

FIG. 2 is a schematic diagram of an alternate configuration for the authentication system; and

FIG. 3 is a schematic diagram of the system using the Internet.

FIG. 4 is a schematic diagram of the configuation of the system for users accessing information from a clients server and/or database.

### DETAILED DESCRIPTION WITH REFERENCE TO THE DRAWINGS

To ensure that a person with whom a company expects to be doing business is present during a login, the present system verifies that person's presence by asking simple questions about that person's unique life experiences, using memories and memory processes as the access key. The present system is also applicable to ATM's enabling devices (e.g., PDA's), account access, etc.

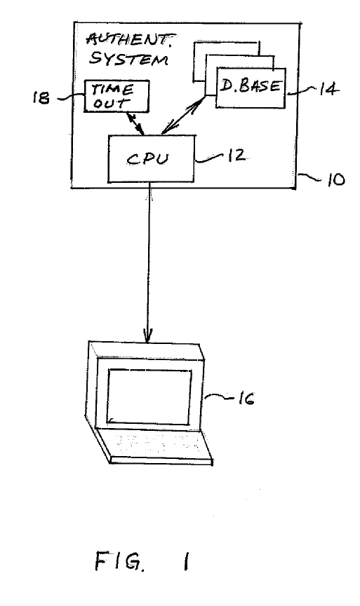

Referring to FIG. 1, the authentication system 10 includes a central processing unit 12 and a database 14 coupled to the CPU 12. A user computer 16 couples to the CPU 12. A time out circuit 18 also couples to the CPU 12 and controls the duration of time allowed for responding to any training or testing question.

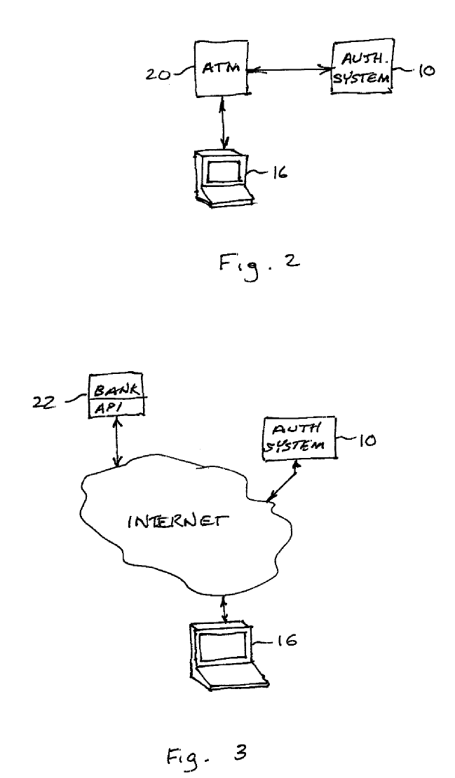

Referring to FIG. 2, the user represented by computer 16 is coupled to an ATM machine 20 which, in turn, is coupled to authentication system 10. Once a user has inserted his/her pin number and bank card, he/she are connected with authentication system 10 through the ATM machine 20. After a few testing questions are successfully answered by the user, access is provided to his/her account.

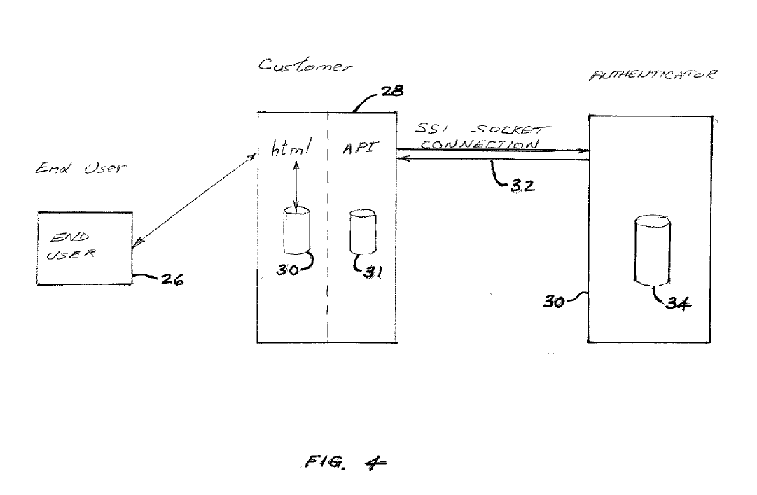

Referring to FIG. 3, a user can access over the Internet a bank 22 and the authentication system 10. In this case after the user inserts the bank card number and password, the bank 22 provides a link to the authentication system 10 so that a user can deal directly with the authentication process.

Referring to FIG. 4, an end user 16 couples to a customer server 28 having a customer database 30. An application program interface (API) and database 32 are installed on the customer system 28 by the authenticator. Connection of the authentication system 30 to the customer is made by means of a secure socket layer (SSL) socket connection 32. The authentication system database 34 communicates with a number of modules in the authentication system 30.

In operation, the end user 26 communicates with the user database 30 and enters his/her user name and password. The database 31 associates the account with a secure identification number (SID) and generates a log. The authentication system 30 has an administration module which resets the account using a scrambled account number that is generated from the SID and transmitted through the SSL socket connection, a back end module that initiates and enters the transaction, a client module that delivers the question and a module that builds the question.

The system builds a unique profile for a user by employing simple language to create a memory that combines pleasant past experiences within the context of logging in. Users begin using the system by answering a few short training questions about their past (e.g., special places, food choices, etc.). The answers to these questions create a unique profile of the user. During subsequent logon sessions the user will receive additional training questions to evolve the profile and increase security protection. Important to this process is that the user does not divulge personal information by entering only a single letter as a response. Obviously, other techniques could be used to achieve this anonymity such as true/false or multiple choice questions.

Once a profile has been established, a user can be authenticated against the profile. After the initial session, a user enters the first letter of his/her first and last name, his/her password and then is asked to answer test questions. Authentication of an individual user is achieved by comparing responses to a randomly chosen subset of test questions with those in the user's authentication profile. If the test question responses match the training question responses, then the user is authenticated and allowed access to the network, website or computer system. The access key is dynamic as the profile constantly changes and sessions are randomly created from that profile.

The objective in training is to create a unique instance of a memory related to a specific past experience/event using clear training questions. The questions are asked with key words designed to re-create that unique, specific past instance. The user generates a memory of the past and then answers the question. First the user is introduced to what will occur (e.g., questions will be asked about their past). The user is then introduced to how to deal with each question by using key words such as “think”, “picture” and “estimate”. Then the user is introduced to how to provide a response (e.g., select an option from a selection grid beneath each question). The following is an example of an initial training session screen:

Welcome to This Authentication Training Session

Answer quickly with the first, clear, vivid answer that comes to mind.

Answer selecting the first letter of a name or a number or if no answer comes to mind, select “None” and continue.

Please follow these instructions when you read the questions:

Please read each question carefully.

To begin select “Enter”.

When you read the word ESTIMATE quickly provide a number that is close to the actual number asked about the event.

When you read the word PICTURE imagine the details in that event.

When you read the word THINK go back in your mind to the age you were at the time of the event.

You will be asked a series of easy questions about events in your life. You already know the answers. For each question quickly answer with the first response that comes to mind.

An example of a training question is the following:

THINK of an event that occurred to a friend a long time ago that made you wish you could be him/her for one day.

PICTURE the friend you wished to be for one day and enter the first letter of their first name.

After the first training session, the user will have established a profile, which can be used to authenticate him/her. The login instructions for authentication are as follows:

Please read each question carefully.

Answer quickly with the first clear, vivid answer that comes to mind.

If no answer comes to mind, simply select “None” and continue.

To begin select “Enter”.

While the initial session includes only training questions, subsequent sessions include a combination of test questions and training questions. This ensures that the profile is constantly expanded and changing.

Test questions are concerned with re-answering a question previously answered in training. The instructions for answering test questions are more abbreviated than the corresponding training questions. At test the user gets only part of the training question. The context is missing. For example, the test question corresponding to the above example of a training question is as follows:

PICTURE the friend you wished to be for one day and enter the first letter of their first name.

By eliminating the context from the question, security is increased at the expense of accuracy. This problem is overcome by using key words between the test and training questions in order to successfully link the test response with the training experience.

Another example of a comparison of training and testing questions is as follows:

Training:

Re-create an early life experience

e.g., Think of one of the first occasions in your life where you saw a fireworks display. Picture watching fireworks long ago and enter the first letter of the location where it happened.

The corresponding testing question is as follows:

Testing:

Re-create a previous training experience

e.g., Picture watching fireworks long ago and enter the first letter of the location where it happened.

Key words such as “fireworks” and “location” specify which training response to replicate.

Obviously, it is important to know how accurately users can identify and answer test questions. For this reason each user accumulates a log of authentications (pass/fail sessions). From the log of authentications, the probability measure for the entire set of users, for example, in a company can be generated.

To see how the number of questions affects security, assume that the probability of guessing a question by guessing the correct letter of the alphabet is 1/26. If there are two questions then the probability of guessing both is 1/676 or 0.0015. Obviously, with just three questions the probability of guessing to authenticate a user increases to approximately 1 in 17,500.

An algorithm is used to ensure that every user session is different and adds new testing questions to the user password profile. Different combinations of train-test question pairs plus new training questions are added within each session.

If a user does not answer training questions he/she cannot advance through the authentication process. If the user does not answer a test question correctly he/she fails. A time out circuit may also be used providing a user with a maximum amount of time in which to answer all of the questions, such as 90 seconds. Once the 90 seconds is reached without successful completion of the answers to the questions, a failure is recorded. Once a user passes he/she may be issued a random password to clear that user at the login access point. Alternatively, the user may simply be granted access to the system, account, or device in question.

If a client requires only a moderate level of security then that client may choose to have users answer only two test questions per session. Other clients wishing a higher level of security and request their users answer more test questions before they are authenticated.

Since the user profiles are continuously changing and each session uses a different subset of the profiles, a user cannot share his/her answers because they do not know what responses will be required until the session happens. Moreover, since none of the questions involve personal identity information, even close family members will not know the answers to the testing questions.

The present system can be added to a host of different systems including verification of parties to a transaction and verification of a user in a user access request. Ordinarily a user name and password are stored on the system being accessed. An initial verification is made followed by a series of known questions which may include first name, last name, telephone and City. Preferably, rather than answering with the complete word only the first letter of the word is entered. This prevents complete biographical information from being stored, which could be used to identify a user. Once the initial verification has been completed, the user can engage the authentication system as described above.

Accordingly, while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

What is claimed is:

1. An authentication system for authenticating an identity of a user, comprising:
(a) a database having a plurality of training questions about said user's past and a corresponding testing question for each of said training questions stored thereon; and
(b) a central processing unit (CPU) coupled to said database and operative in both a training session and a testing session to select a sub-set of said training questions and to pose them sequentially to said user, store user responses to said subset of training questions in said user's profile and, in said testing session to select a subset of said testing questions and to pose them to said user, and to check responses of said user to said subset of test questions against said user's profile, wherein each of said testing questions is based on a corresponding training question without a context.

2. The system according to claim 1, wherein key words in said training questions are replicated in said testing questions.

3. The system according to claim 1, including a password authentication system.

4. The system according to claim 1, wherein responses are made by selecting a letter on an alphabetic selection grid.

5. The system according to claim 1, wherein said database has a log of pass and fail recordals for each training/test pair and for each user.

6. The system according to claim 1, including a time out circuit monitoring and operative to limit the time available to answer said training and said testing questions.

7. The system according to claim 1, wherein each of said training questions follows a common format so that users may easily and consistently follow instructions.

8. The system according to claim 1, including a central processing unit (CPU) coupled to said database and operative to select a subset of said training and said testing questions wherein the testing questions in said subset of testing questions are randomly selected.

9. The system according to claim 1, wherein said training questions do not elicit any identifying information.

10. The system according to claim 1, including a performance monitor operative to record pass and fails for each one of said test questions for each user.

11. The system according to claim 1, wherein said CPU measures session initiation, time of sending questions, time of each answer, time of sending a random password which is issued after a session has been passed and time of using the random password.

12. A method of authentication, comprising:
(a) providing a database having training questions and testing questions, user responses to said training questions and identity information as part of said user profile, wherein each of said testing questions is based on a corresponding training question without a context and wherein said training questions are questions about past events in said user's life; and
(b) during a training session, selecting a subset of said training questions from said database and displaying said training questions to the user;
(c) storing responses to said training questions in the user profile on said database;
(d) during a testing session, selecting a subset of said training questions from said database and displaying said subset of said training questions to the user;
(e) during said testing session, storing responses to said subset of said training questions in the user profile on said database;
(f) during said testing session, selecting a subset of said testing questions from said database and displaying said subset of said testing questions to the user; and
(g) checking a response to each one of said testing questions of said subset of testing questions against responses stored in said user profile to determine if each one of said responses to said testing question in said subset of testing questions is a pass or fail.

13. The method according to claim 12, including terminating said session if any of said responses to said subset of testing questions is a fail.

14. The method according to claim 12, including the same key words are present in both said training and testing questions.

15. The method according to claim 12, including limiting a time during which each of said training questions is displayed so that a user is prevented from over-elaborating an experience.

16. The method according to claim 12, wherein each of said training questions follows the same format so that users may easily and consistently follow instructions.

17. The method according to claim 12. wherein each subset of testing questions is randomly generated.

18. The method according to claim 12, wherein each testing session is different.

19. The method according to claim 12, wherein said training questions do not elicit any information that could be used to determine a person's identity.

20. The method according to claim 12, including monitoring pass and fails for each test question per each individual user.

21. The method according to claim 12, including storing time of initiation of a session user, time questions are sent, time of each answer to the questions, time of sending of random password which is issued after a session has been passed, and time of using the random password.

22. The method according to claim 12, including generating a random password to clear a user at a login access point if that user passes the testing session.
